(19) United States
(12) Patent Application Publication
(10) Pub. No.: US 2005/0052019 A1
(43) Pub. Date: Mar. 10, 2005

(54) Vented rotating flange assembly for plastic lined pipe

(75) Inventor: Frank Stephen Schroeder, Destin, FL (US)

Correspondence Address: Frank S. Schroeder, 1223 Deerwood Drive, Destin, FL, 32550, US

(73) Assignee: Flangeman Marketing, Inc., Destin, FL (US)

(21) Appl. No.: 10/660,018

(22) Filed: Sep. 10, 2003

(51) Int. Cl. F16L 55/00

(52) U.S. Cl. 285/13; 285/405; 285/14; 285/924

(57) ABSTRACT

The subject invention provides a means of flanging a plastic lined steel pipe in a field fabrication environment by either threading or welding the flange adapter to the pipe housing, employing a rotating back up flange for easy bolt hole alignment during assembly, and providing a vent path for permeating gases trapped between the plastic liner and the pipe housing to escape.

### CROSS-REFERENCE TO RELATED APPLICATIONS

Field of Search: 285/55,13,14,363 138/109,114,140,148

References Cited

U.S. Patent Documents
U.S. Pat. No. 4,127,287 November 1978 Davies 285/55
U.S. Pat. No. 4,281,859 August 1981 Davies 285/55
U.S. Pat. No. 4,537,425 August 1985 Press et al. 285/55
U.S. Pat. No. 4,643,457 February 1987 Press 285/55
U.S. Pat. No. 4,691,740 September 1987 Svetlik et al. 138/109
U.S. Pat. No. 5,149,142 September 1992 Walko 285/55
U.S. Pat. No. 5,954,371 September 1999 Koke et al. 285/55

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention pertains to pipe venting systems and in particular to a venting system specially suited for use in conjunction with plastic lined pipe.

Lined pipe is often utilized in handling of corrosive fluid materials. Lined pipe generally consists of a rigid outer pipe and an inner corrosive resistant plastic lining. Although the plastic lining materials typically used are highly resistant to corrosion, they are susceptible to permeation by certain gases. Permeated gases then become trapped between the liner and the outer pipe and can, if not properly vented, cause the liner to distort, separate from the pipe, and at times cause its complete collapse or rupture.

Plastic-lined process pipe typically falls into one of three subcategorizes: Loose-lined pipe, interference fit pipe and swaged pipe.

Loose-lined pipes are typically manufactured by slipping a pre-formed plastic liner into a flanged pipe, flaring the liner over the structurally rigid flange face, and bolting the flange to an adjacent flange. In loose-lined pipe, the liner is thus retained within the pipe by the compressive force exerted on the flared portion of the liner at the flange face. Loose-lined pipe is generally sold as its components, e.g., as pipe, plastic liners, and flanges. In the field, the liner may be inserted into the flanged pipe, and may be flared as described above.

Interference fit plastic-lined pipe is typically formed by compressing a pre-formed plastic liner having an outer diameter greater than the inner diameter of the pipe by passing it through a sizing die, and inserting the compressed liner into the pipe before the liner expands. The memory of the plastic causes the liner to exert force upon the inner wall of the pipe, serving to assist in retaining the liner within the pipe. Because of the special equipment required to achieve the interference fit relationship, interference fit pipe is generally available as pre-lined pipe segments.

Swaged pipe is typically formed by inserting a pre-formed plastic liner into an oversized pipe and physically compressing both the pipe and the liner under tremendous pressure such that the liner and the pipe are reduced in size to the finished diameters. To further facilitate retention of the liner within the pipe segment, pipe segments to be lined may be “picked” to provide barbs and recessed portions into which the liner is directed during swaging. Due to the special apparatus required to swage pipe, swaged pipe is generally available as pre-lined pipe segments.

The most conventional method of venting permeated gases is to drill a series of vent holes in the pipe along its length. The vent holes are generally of a relatively small size and few in number. The small diameter holes, however, often become plugged by subsequent sandblasting and painting operations, or the addition of insulation, which frustrate proper venting. When field fabrication is required, the holes must be added to the pipe at the site. It is only possible to add such vent holes at the site on loose lined pipe. Such field work greatly increases the labor costs and time of installation, since the fabricator must (before installation) remove the liner, drill and de-burr the holes, and then push the liner back into place. Field applied venting of interference fit pipe or swaged pipe must be done at the flange since the liner cannot be moved to facilitate drilling.

Other methods of pipe venting include the use of locking collars positioned at the juncture of two lined pipes, venting collars positioned between the pipe flange and the liner flare, and specially designed pipe casings and flanges which centralize the venting openings to facilitate containment thereof.

With the use of any venting system, failure of the lining can cause an extremely hazardous and troublesome situation. More particularly, the paths through which venting occurs are random, unpredictable and completely open to the surrounding environment. Failure of the lining could, then, cause severe leakage into the surrounding environment.

### BRIEF SUMMARY OF THE INVENTION

Permeated gases trapped between the liner and the outer casing are vented to atmosphere in a plastic lined pipe, using a threaded or slip-on socket stub-end with a rotating back up flange assembly which defines at least one predetermined weep hole through which the gasses may exit.

The present invention utilizes a special socket stub end and rotating back-up flange for field fabrication of plastic lined steel pipe. The socket stub end can be made in a threaded mode or a slip-on-for welding mode to accommodate the user's preferred method of attachment to the pipe end. The vent hole travels from behind the socket stop on the inside to behind the stub end stop on the outside and is covered (but not sealed off) by the inside of the back-up flange when the pipe is installed. Because the pipe does not form an air-tight seal against the stub end's socket in either the threaded mode or the slip-on mode, permeation trapped between the plastic liner and the pipe housing can be vented around the end of the steel pipe, behind the socket stop and under the back up flange. The back side of the stub end has a radius and the back-up flange has a corresponding chamfer on the inside opening. When the back-up flange is drawn up to the stub end in installation, the flange rides off of the stub end shaft (because of the radius and chamfer on the stub end and flange respectively) and cannot seal off the vent hole. Because the vent hole exits under the back-up flange, the vent hole cannot be easily clogged once the pipe is installed. Further, any leakage caused by rupture of the lining may be effectively contained from spilling into the surrounding environment.

For loose-lined pipe, either the threaded or the welded mode of the socket stub end can be used. However, if the liner cannot be moved (as in interference fit or swaged lined pipe) only the threaded mode can be used and in such cases only a venting system at the flange can be employed since installing vent holes in the pipe after the liner is installed at the factory would violate the system.

The socket stub end is designed with a radius at the inside face to allow a smooth transition for the plastic liner to be flared over the face of the stub end forming the pipe gasket. The face of the stub end is grooved to lock the flared liner against movement (a phenomenon commonly known as creep). Employing a rotating back up flange on a field flare system allows for easy bolt hole alignment in installation.

### BRIEF DESCRIPTION OF THE SEVERAL VIEWS OF THE DRAWING

Drawing 1/2

FIG. 1 is a cross section of a slip-on socket stub end

FIG. 2 is a cross section of a back-up flange

FIG. 3 is a cross section of FIG. 1 and FIG. 2 assembly

Drawing 2/2

FIG. 4 is a cross section of a threaded socket stub end

FIG. 5 is a cross section of a back-up flange

FIG. 6 is a cross section of FIG. 4 and FIG. 5 assembly

### DETAILED DESCRIPTION OF THE INVENTION

### FIRST EMBODIMENT

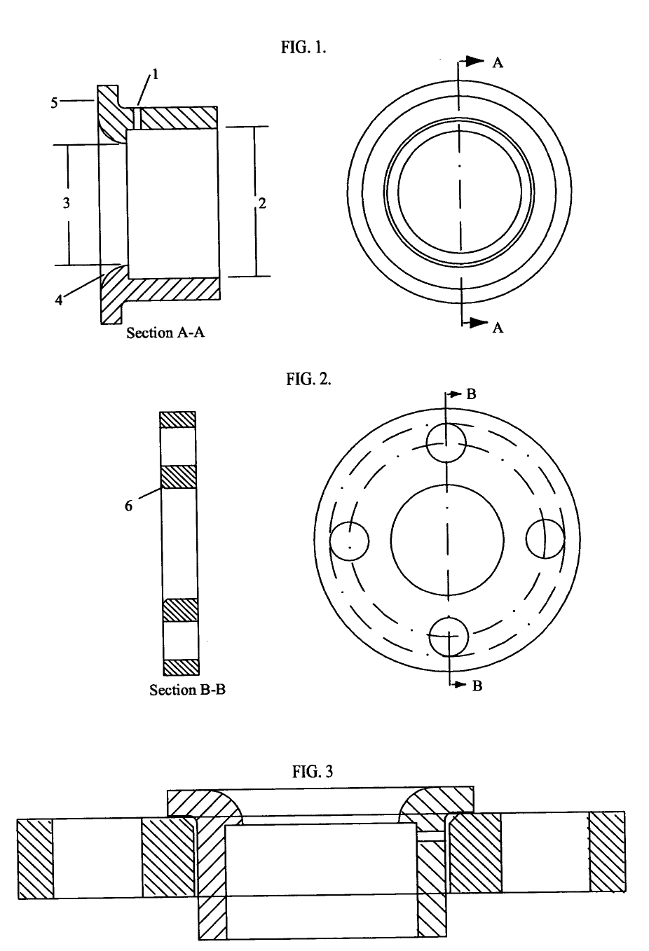

The slip-on socket stub end shown in FIG. 1 is usually made of carbon steel, but can also be made of stainless steel to conform to the pipe housing being fabricated. The vent hole (1) extends from behind the stub end at the surface to just behind the socket of the inner surface. The inner bore of the stub end (2) is such that it will fit over a standard pipe housing and be welded to the pipe at the back end. The opening at the face of the stub end (3) must be adequate for the plastic liner to extend through without interference. The radius at the face (4) is designed for a smooth transition when the extended plastic liner is heat flared over the face to form the gasket for the flanged joint. The face of the stub end (5) is grooved to lock the liner to the stub end face to prevent movement or creep.

The back-up flange in FIG. 2 can be made of carbon steel, ductile iron, or stainless steel. The back-up flange can be furnished in 150# rating or 300# rating depending on the pressure requirements of the piping system. The back up flange has a chamfer on the front of the opening (6) to facilitate an intimate fit backing up the stub end (FIG. 3)

Assembly of the slip-on socket stub end system involves moving the plastic liner in a loose lined pipe well away from the end of the pipe being fabricated. The pipe and plastic liner are cut and prepared per the manufacturer's field flare instructions for the type of plastic lined pipe being fabricated. The back-up flange is placed over the end of the pipe with the ID chamfer facing the pipe end and the stub end inserted over that end. The stub end is back welded around the base to the pipe, and the back-up flange is moved up behind the stub end. The plastic liner is moved to extend through the opening of the stub end and the plastic liner is heat flared over the face forming the gasket for the pipe in accordance with the plastic lined pipe manufacturer's instructions.

### SECOND EMBODIMENT

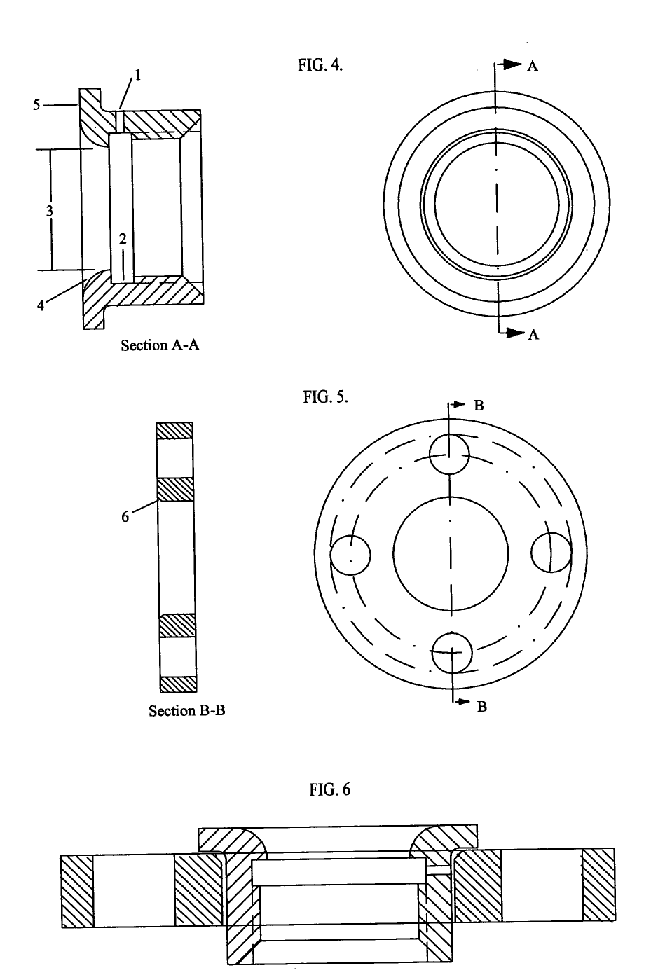

The threaded socket stub end shown in FIG. 4 is usually made of carbon steel, but can also be made of stainless steel to conform to the pipe housing being fabricated. The tapped thread pattern can be an ANSI straight thread, an ANSI tapered thread, or an ISO metric thread depending on the thread being applied to the attaching pipe housing. The vent hole (1) extends from behind the stub end at the surface to just behind the socket of the inner surface. A threaded stub end has a recessed space (2) between the end of the thread and the back of the socket to facilitate tapping the thread during manufacture. The vent hole extends into this recessed area on the inside of the socket. The opening at the face of the stub end (3) must be adequate for the plastic liner to extend through without interference. The radius at the face (4) is designed for a smooth transition when the extended plastic liner is heat flared over the face to form the gasket for the flanged joint. The face of the stub end (5) is grooved to lock the liner to the stub end face to prevent movement or creep.

The back-up flange in FIG. 5 can be made of carbon steel, ductile iron, or stainless steel. The back-up flange can be furnished in 150# rating or 300# rating depending on the pressure requirements of the piping system. The back up flange has a chamfer on the front of the opening (6) to facilitate an intimate fit backing up the stub end (FIG. 6)

Assembly of the threaded socket stub end system involves cutting and preparing the pipe and plastic liner, and threading the end of the steel pipe per the manufacturer's field flare instructions for the type of plastic lined pipe being fabricated. The back-up flange is placed over the end of the pipe, the threaded stub end threaded onto the pipe housing, and the back-up flange is moved up behind the stub end. The extending plastic liner is heat flared over the face forming the gasket for the pipe in accordance with the plastic lined pipe manufacturer's instructions.

1. A pipe segment comprising:
a pipe having a pair of ends;
a rotating back up flange is placed over an end of said pipe;
a socket stub end placed on the said end of said pipe and affixed to said pipe;
a liner, received within said pipe, having a liner flare extending radially outward and positioned in overlapping relation with said socket stub end face forming a gasket; and
said socket stub end having at least one predetermined vent hole having an inlet opening located behind said socket and an outlet opening located behind said stub end, whereby permeated gases trapped between said pipe and said liner can be vented through at least one defined vent hole.
